(19) United States
(12) Patent Application Publication
(10) Pub. No.: US 2008/0050107 A1
(43) Pub. Date: Feb. 28, 2008

(54) Information processing apparatus

(75) Inventors: Minoru Yamashita, Tokyo (JP); Takato Yokouchi, Tokyo (JP); Ai Matsui, Yokohama-shi (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: KABUSHIKI KAISHA TOSHIBA, Tokyo (JP)

(21) Appl. No.: 11/606,870

(22) Filed: Nov. 30, 2006

(30) Foreign Application Priority Data
Aug. 25, 2006 (JP) P2006-229456

(51) Int. Cl. G03B 13/18

(52) U.S. Cl. 396/89

(57) ABSTRACT

According to an aspect of the invention, there is provided an information processing apparatus including: a display unit configured to display a plurality of informations having a plurality of hierarchies; a focus control unit configured to focus at least one of the plurality of informations to be displayed by the display unit; a recognition unit configured to recognize whether or not a focus movement speed in at least one of the plurality of informations controlled by the focus control unit is smaller than a prescribed reference value; and a first control unit configured to control the display unit to display at least one of the plurality of informations according to the recognition result by the recognition unit.

### CROSS-REFERENCE TO RELATED APPLICATIONS

This application is based on and claims the benefit of priority from the prior Japanese Patent Application No. 2006-229456, filed on Aug. 25, 2006; the entire contents of which are incorporated herein by reference.

### BACKGROUND

1. Technical Field

The present invention relates to an information processing apparatus, and in particular, to an information processing apparatus that can display a menu having a plurality of hierarchies.

2. Description of Related Art

In recent years, cellular phones as information processing apparatuses have not only a simple communication function by a telephone call but also a plurality of functions, such as a directory function, a mail function through a network, such as Internet, a browser function that can read a web page, and the like.

Accordingly, there is suggested a technology that hierarchizes various functions in advance and displays the hierarchized functions on a menu screen as a menu (function menu) (for example, see JP-A-2003-125042).

According to JP-A-2003-125042, a small screen corresponding to each genre is displayed at a display position on a menu screen according to an operation position on an operation panel of a display unit. Therefore, a user can intuitively know an operating key to operate.

### SUMMARY

According to an aspect of the invention, there is provided an information processing apparatus comprising: a display unit configured to display a plurality of informations having a plurality of hierarchies; a focus control unit configured to focus at least one of the plurality of informations to be displayed by the display unit; a recognition unit configured to recognize whether or not a focus movement speed in at least one of the plurality of informations controlled by the focus control unit is smaller than a prescribed reference value; and a first control unit configured to control the display unit to display at least one of the plurality of informations according to the recognition result by the recognition unit.

According to another aspect of the invention, there is provided an information processing apparatus comprising: a display unit configured to display a plurality of informations having a plurality of hierarchies; a focus control unit configured to focus at least one of the plurality of informations to be displayed by the display unit; a focus time judgment unit configured to judge whether or not the same information is focused by the focus control unit for a prescribed time or more; and a first control unit configured to control the display unit to display at least one of the plurality of informations according to a judgment result by the focus time judgment unit.

### BRIEF DESCRIPTION OF THE DRAWINGS

FIGS. 1A and 1B are exemplary exterior views showing an exterior structure of a camera-equipped digital cellular phone according to an embodiment.

FIGS. 2A and 2B are exemplary exterior views showing another exterior structure of a camera-equipped digital cellular phone according to the embodiment.

FIG. 3 is an exemplary block diagram showing the internal structure of a camera-equipped digital cellular phone according to the embodiment.

FIG. 4 is an exemplary flowchart illustrating a menu display control processing in the camera-equipped digital cellular phone shown in FIG. 3.

FIG. 5 is an explanatory view illustrating the structure of hierarchy menus having a plurality of hierarchies.

FIG. 6 is an exemplary transition view of a display screen to be displayed on a liquid crystal display of FIG. 3.

FIG. 7 is an exemplary transition view of a display screen to be displayed on the liquid crystal display of FIG. 3.

FIG. 8 is an exemplary transition view of a display screen to be displayed on the liquid crystal display of FIG. 3.

FIGS. 9A to 9C are exemplary transition views of a display screen to be displayed on the liquid crystal display of FIG. 3.

FIG. 10 is an explanatory view illustrating hierarchy menus to be displayed on the liquid crystal display when a focus movement speed is high and low.

FIG. 11 is a flowchart illustrating another menu display control processing in the camera-equipped digital cellular phone shown in FIG. 3.

### DESCRIPTION OF THE EMBODIMENTS

Hereinafter, embodiments of the invention will be described with reference to the drawings.

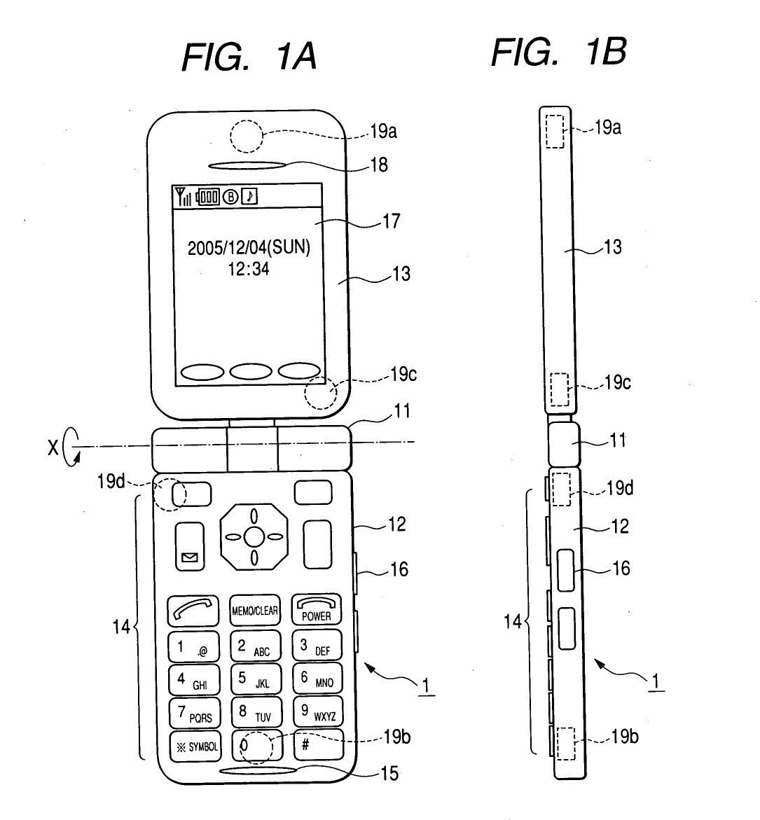

FIGS. 1A and 1B show the exterior structure of a camera-equipped digital cellular phone 1 that can be applies as an information processing apparatus. FIG. 1A shows the exterior structure of the camera-equipped digital cellular phone 1 in a state where it is unfolded 180 degrees as viewed from the front surface. FIG. 1B shows the exterior structure of the camera-equipped digital cellular phone 1 in a state where it is unfolded as viewed from the side surface.

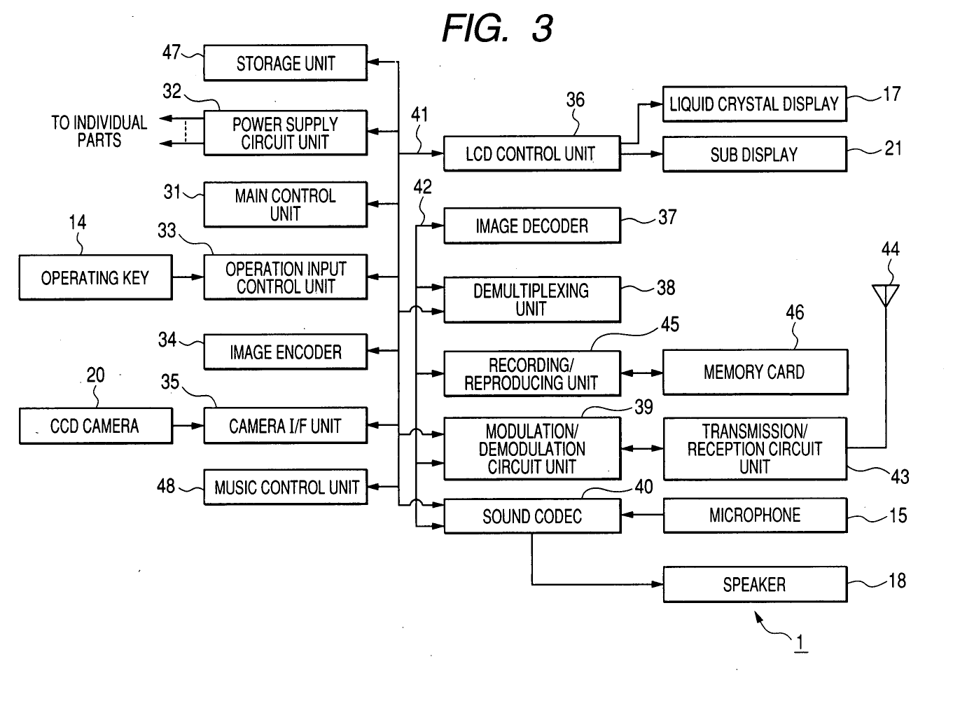

As shown in FIGS. 1A and 1B, in the camera-equipped digital cellular phone 1, a first casing 12 and a second casing 13 are hinged by a hinge 11 at its central portion. The camera-equipped digital cellular phone 1 is formed to be foldable in a direction of an arrow X through the hinge 11. An antenna (an antenna 44 of FIG. 3 described below) for transmission/reception is provided at a predetermined position in the camera-equipped digital cellular phone 1. With the internal antenna, the camera-equipped digital cellular phone 1 transmits and receives an electrical wave to and from a base station (not shown).

On a surface of the first casing 12, operating keys 14, such as numeric keys of ‘0’ to ‘9’, a call key, a redial key, an end/power key, a clear key, an electronic mail key, and the like, are provided. Various instructions can be input using the operating keys 14.

At an upper portion of the first casing 12, a directional key and an enter key are also provided as operating keys 14. A user operates the directional key in a vertical or horizontal direction, thereby moving a cursor in the vertical or horizontal direction. Specifically, various operations, such as a scroll operation of a directory or an electronic mail displayed on a liquid crystal display 17 provided in the second casing 13, are executed, a page rolling operation of a simplified home page, and a forward operation of an image.

Further, by pushing the enter key, various functions can be decided. For example, according to the operation of the directional key in the first casing 12 by the user, a desired telephone number is selected among a plurality of telephone numbers of the directory displayed on the liquid crystal display 17. Then, when the enter key is pushed in an inner direction of the first casing 12, the selected telephone number is decided, and then a call request processing of the telephone number is performed.

Further, in the first casing 12, an electronic mail key is provided on a left side of the directional key and the enter key. If the electronic mail key is pushed in the inner direction of the first casing 12, a mail transmission/reception function can be called. On a right side of the directional key and the enter key, a browser key is provided. If the browser key is pushed in the inner direction of the first casing 12, data of Web pages can be read. Moreover, the electronic mail key and the browser key provided the left and right sides of the directional key and the enter key have various functions, such as ‘Yes’ and ‘No’, according to a screen to be displayed on the liquid crystal display 17, and thus they are called a soft 1 key and a soft 2 key, respectively.

In addition, in the first casing 12, a microphone 15 is provided below the operating keys 14. With the microphone 15, a user's voice during calling is collected. Further, in the first casing 12, a side key 16 that operates the camera-equipped digital cellular phone is provided.

Moreover, a battery pack (not shown) is provided at a rear surface of the first casing 12. If the end/power key becomes an ON state, power is supplied to individual circuits from the battery pack, such that the camera-equipped digital cellular phone 1 starts to operate.

In the first casing 12, a memory card slot into which a removable memory card (a memory card 46 of FIG. 3 described below) is inserted is provided at a predetermined position at a lower portion of the first casing 12. If a memo button (not shown) is pushed, a voice of a person to call during calling can be recorded in the memory card, and an electronic mail, a simplified home page, and an image captured by a CCD camera can be recorded according to an operation of the user.

Here, the memory card is a kind of a flash memory card, such as a NAND flash memory or a NOR flash memory. The memory card is formed by incorporating a flash memory device, which is an electrically rewritable or erasable nonvolatile memory, in a small and thin plastic case. In such a memory card, various kinds of data, such as image, sound, and music can be rewritten and read out through a ten-pin terminal.

Further, the memory card uses a unique serial protocol that can secure comparability with an apparatus to be used even though the specification of an internal flash memory changes according to large capacity, thereby implementing high-speed performance. Further, with an erroneous erasure preventing switch, high reliability can be secured.

Accordingly, the camera-equipped digital cellular phone 1 is configured such that such a memory card can be inserted thereinto, and thus data sharing with other electronic apparatuses can be realized through the memory card.

In addition, since a module (chip) for expanding a predetermined function may be incorporated in the memory card, and the memory card may be installed in on the memory card slot (not shown), the function of the camera-equipped digital cellular phone 1 can be further expanded.

For example, a memory card, into which a noncontact IC (Integrated Circuit) chip is incorporated, may be mounted on the camera-equipped digital cellular phone 1. Accordingly, even though the noncontact IC chip is not incorporated into the camera-equipped digital cellular phone 1, the camera-equipped digital cellular phone 1 can be expanded to have an electronic payment function, like a case where the noncontact IC chip is incorporated.

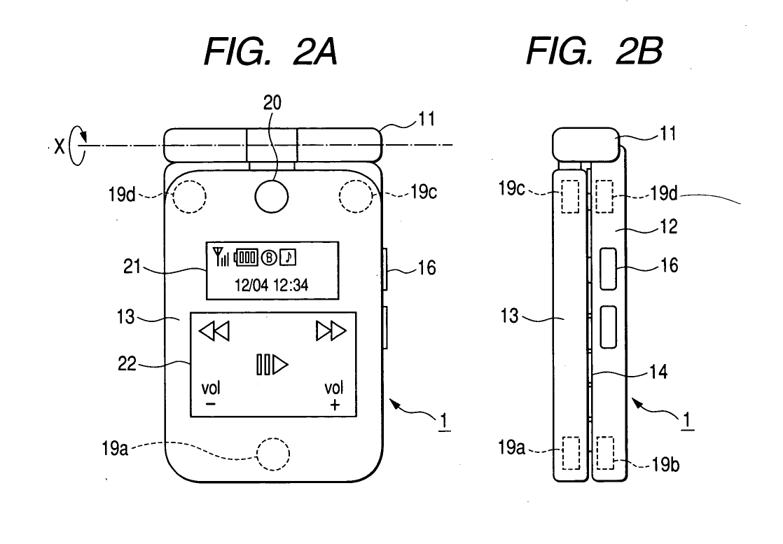

Meanwhile, the liquid crystal display 17 (a main display) is provided at a front surface of the second casing 13. On the liquid crystal display 17, in addition to a reception state of an electrical wave, a residual battery charge, the name or telephone number of a person to call or a telephone number registered in the directory, and a transmission history, the content of an electronic mail, a simplified home page, an image captured by the CCD (Charge Coupled Device) camera (a CCD camera 20 of FIG. 2 described below), contents received by an external contents server (not shown), and contents stored in the memory card (a memory card 46 of FIG. 3 described below) are displayed. Further, a speaker 18 is provided at a predetermined position above the liquid crystal display 17. With the speaker 18, the user can perform a voice call.

At predetermined positions in the first casing 12 and the second casing 13, magnetic sensors 19a, 19b, 19c, and 19d are provided so as to detect the state of the camera-equipped digital cellular phone 1.

FIGS. 2A and 2B show another exterior structure of the camera-equipped digital cellular phone 1. The state of the camera-equipped digital cellular phone 1 shown in FIG. 2 is a state that rotated in the direction of the arrow X from the state of the camera-equipped digital cellular phone 1 shown in FIG. 1. Moreover, FIG. 2A shows the exterior structure of the camera-equipped digital cellular phone 1 in a state where it is folded as viewed from the front surface. FIG. 2B shows the exterior structure of the camera-equipped digital cellular phone 1 in a state where it is folded as viewed from the side surface.

The CCD camera 20 is provided at an upper portion of the second casing 13. With the CCD camera 20, a desired subject can be captured. Below the CCD camera 20, a sub display 21 is provided. On the sub display 21, an antenna pictograph indicating a current sensitivity level of the antenna, a battery pictograph indicating a current residual battery charge of the camera-equipped digital cellular phone 1, and a current time are displayed.

An electrostatic touch pad 22 is provided below the sub display 21. The electrostatic touch pad 22 has a single touch pad in appearance, but has a plurality of sensors (not shown). If the user touches the vicinity of a sensor, it is detected by the sensor, and then a rewind operation, a fast forward operation, a volume down operation, a volume up operation, a play operation, and a pause operation are executed.

FIG. 3 shows the internal structure of the camera-equipped digital cellular phone 1.

As shown in FIG. 3, in the camera-equipped digital cellular phone 1, a power supply circuit unit 32, an operation input control unit 33, an image encoder 34, a camera interface unit 35, an LCD (Liquid Crystal Display) control unit 36, a demultiplexing unit 38, a modulation/demodulation circuit unit 39, a sound codec 40, a storage unit 47, and a music control unit 48 are connected to one another with respect to a main control unit 31, which performs an overall control of individual parts of the first casing 12 and the second casing 13, through a main bus 41. Further, the image encoder 34, an image decoder 37, the demultiplexing unit 38, the modulation/demodulation circuit unit 39, the sound codec 40, and a recording/reproducing unit 45 are connected to one another through a synchronous bus 42.

When the end/power key becomes the ON state by the operation of the user, the power supply circuit unit 32 supplies power from the battery pack to the individual parts, such that the camera-equipped digital cellular phone 1 starts to operate.

The main control unit 31 has a CPU (Central Processing Unit), a ROM (Read Only Memory), and a RAM (Random Access Memory), and the like. The CPU executes various kinds of processing according to programs stored in the ROM or various application programs loaded on the ROM from the storage unit 47, generates various control signals, and supplies the control signals to the individual parts so as to perform the overall control of the camera-equipped digital cellular phone 1. The RAM appropriately stores data required for executing various kinds of processing.

Moreover, a timer that accurately measures current date and time is incorporated into the main control unit 31.

Here, various application programs to be executed by the CPU may be installed in the ROM or the storage unit 47 in advance. Further, various application programs to be executed by the CPU may be downloaded to the camera-equipped digital cellular phone 1 by communication through a base station (not shown) and installed in the storage unit 47. In addition, various application programs to be executed by the CPU may be stored in the memory card 46. In this case, the application programs may be read out by the recording/reproducing unit 45 and installed in the storage unit 47.

The camera-equipped digital cellular phone 1 converts and compresses a sound signal collected by the microphone 15 in a voice call mode into a digital sound signal using the sound codec 40 on the basis of the control of the main control unit 31, and performs a spread spectrum processing on the converted and compressed digital sound signal using the modulation/demodulation circuit unit 39. Then, the camera-equipped digital cellular phone 1 performs a digital-to-analog conversion processing and a frequency conversion processing on the digital signal subject to the spread spectrum processing using the transmission/reception circuit unit 43 and then transmits the processed signal through the antenna 44.

Further, the camera-equipped digital cellular phone 1 amplifies a reception signal received by the antenna 44 in the voice call mode, and performs a frequency conversion processing and an analog-to-digital conversion processing on the reception signal. Then, the camera-equipped digital cellular phone 1 performs a de-spread spectrum processing on the processed reception signal using the modulation/demodulation circuit unit 39, expands the signal subject to the de-spread spectrum processing using the sound codec 40, converts the signal into an analog sound signal, and outputs the converted analog sound signal through the speaker 18.

In addition, when transmitting an electronic mail in a data communication mode, the camera-equipped digital cellular phone 1 sends text data of the electronic mail input by the operation of the operating keys 14 to the main control unit 31 through the operation input control unit 33. The main control unit 31 performs a spread spectrum processing on the text data using the modulation/demodulation circuit unit 39, performs a digital-to-analog conversion processing and a frequency conversion processing using the transmission/reception circuit unit 43, and transmits the processed data to the base station (not shown) through the antenna 44.

In contrast, when receiving an electronic mail in the data communication mode, the camera-equipped digital cellular phone 1 restores original text data by performing a de-spread spectrum processing on the reception signal-received from the base station (not shown) through the antenna 44 using the modulation/demodulation circuit unit 39, and displays the restored text data on the liquid crystal display 17 through the LCD control unit 36 as an electronic mail.

Next, the camera-equipped digital cellular phone 1 may record the received electronic mail in the memory card 46 through the recording/reproducing unit 45 according to the operation of the user.

When an image signal is not transmitted, the camera-equipped digital cellular phone 1 directly displays an image signal captured by the CCD camera 20 on the liquid crystal display 17 through the camera interface unit 35 and the LCD control unit 36.

When the image signal is transmitted in the data communication mode, the camera-equipped digital cellular phone 1 supplies the image signal captured by the CCD camera 20 to the image encoder 34 through the camera interface unit 35.

The image encoder 34 compresses and encodes the image signal supplied from the CCD camera 20 according to a predetermined encoding system, such as MPEG (Moving Picture Experts Group) 4 or the like, so as to convert the image signal into a coded image signal, and sends the converted coded image signal to the demultiplexing unit 38. Simultaneously, the camera-equipped digital cellular phone 1 sends sound collected by the microphone 15 during image capturing by the CCD camera 20 to the demultiplexing unit 38 through the sound codec 40 as a digital sound signal.

The demultiplexing unit 38 demultiplexes the coded image signal supplied from the image encoder 34 and the sound signal supplied from the sound codec 40 according to a predetermined method, and performs a spread spectrum processing on the resultant demultiplexed signal using the modulation/demodulation circuit unit 39. Then, the camera-equipped digital cellular phone 1 performs a digital-to-analog conversion processing and a frequency conversion processing on the signal subject to the spread spectrum processing using the transmission/reception circuit unit 43 and transmits the processed signal through the antenna 44.

In contrast, in the data communication mode, the camera-equipped digital cellular phone 1 may receive data of a Web page.

That is, in the camera-equipped digital cellular phone 1, in the data communication mode, if data for requesting the Web page is received, the data of the Web page is transmitted through the base station (not shown) according to the request. The data of the Web page is received by the transmission/reception circuit unit 43 and the modulation/demodulation circuit unit 39 through the antenna 44. The transmission/reception circuit unit 43 and the modulation/demodulation circuit unit 39 sends the received data of the Web page to the main control unit 31.

The main control unit 31 analyzes the data of the Web page and creates a screen (image) based on the analysis. The created screen is supplied from the main control unit 31 to the liquid crystal display 17 through the LCD control unit 36 and then displayed on the liquid crystal display 17. That is, at least an application program of a Web browser is installed in the ROM of the main control unit 31 or the storage unit 47. Then, the CPU of the main control unit 31 functions a Web browser by executing the application program of the Web browser on the RAM and analyzes the data of the Web page.

Further, for example, when data of a motion picture file linked to the Web page is received in the data communication mode, the camera-equipped digital cellular phone 1 performs a de-spread spectrum processing on a reception signal received from the base station (not shown) through the antenna 44 using the modulation/demodulation circuit unit 39, and sends the resultant multiplexed signal to the demultiplexing unit 38.

The demultiplexing unit 38 separates the multiplexed signal into the coded image signal and the sound signal, and supplies the coded image signal and the sound signal to the image decoder 37 and the sound codec 40 through the synchronous bus 42, respectively. The image decoder 37 decodes the coded image signal by a decoding system corresponding to a predetermined encoding system, such as MPEG 4 or the like, so as to generate a reproduction motion picture signal and supplies the reproduction motion picture signal to the liquid crystal display 17 through the LCD control unit 36. Accordingly, for example, motion picture data in the motion picture file linked to the Web page or the like is displayed.

Simultaneously, the sound codec 40 converts the sound signal into an analog sound signal and then supplies the converted analog sound signal to the speaker 18. Accordingly, for example, the sound signal in the motion picture file linked to the Web page or the like is reproduced. In this case, like the electronic mail, the camera-equipped digital cellular phone 1 may also record the data linked to the received Web page or the like in the memory card 46 through the recording/reproducing unit 45 according to the operation of the user.

The storage unit 47 has, for example, a flash memory that is an electrically rewritable or erasable nonvolatile memory. The storage unit 47 stores various application programs that are executed by the CPU of the main control unit 31 or various groups of data. Further, if necessary, the storage unit 47 may store the received electronic mail or the motion picture data in the motion picture file linked to the received Web page according to the operation of the user.

The music control unit 48 controls the execution of a play operation and a pause operation, a rewind operation, a fast forward operation, a volume down operation, and a volume up operation of audio data stored in the storage unit 47.

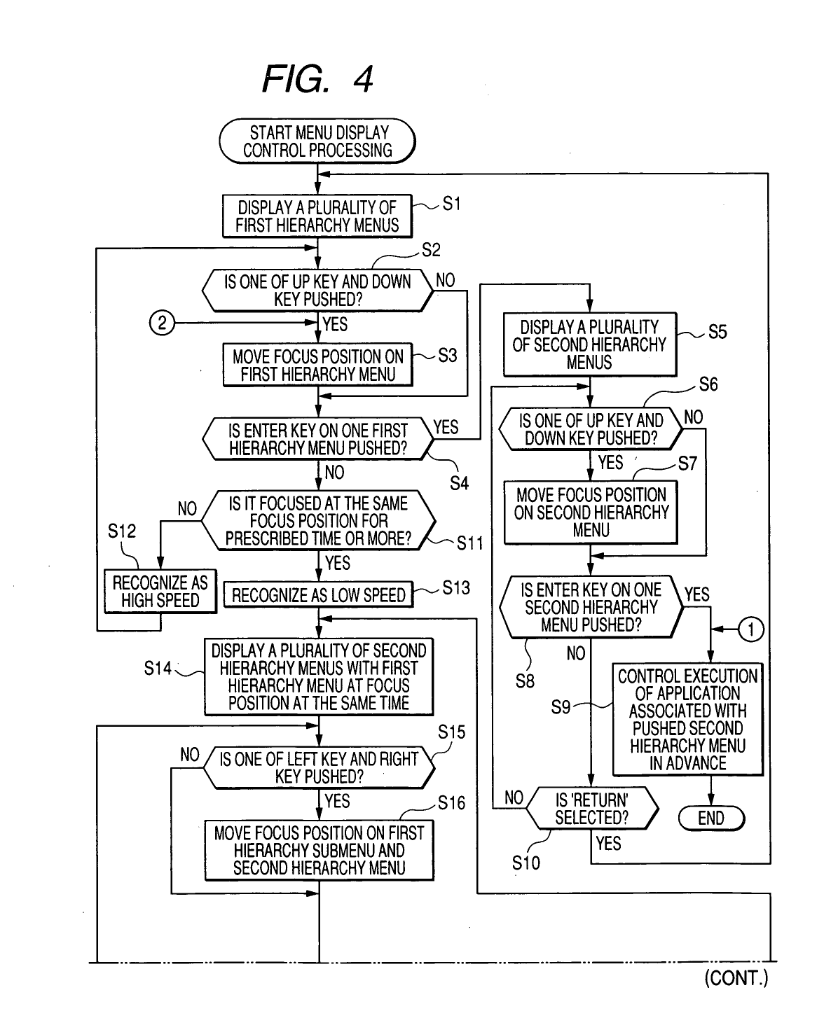

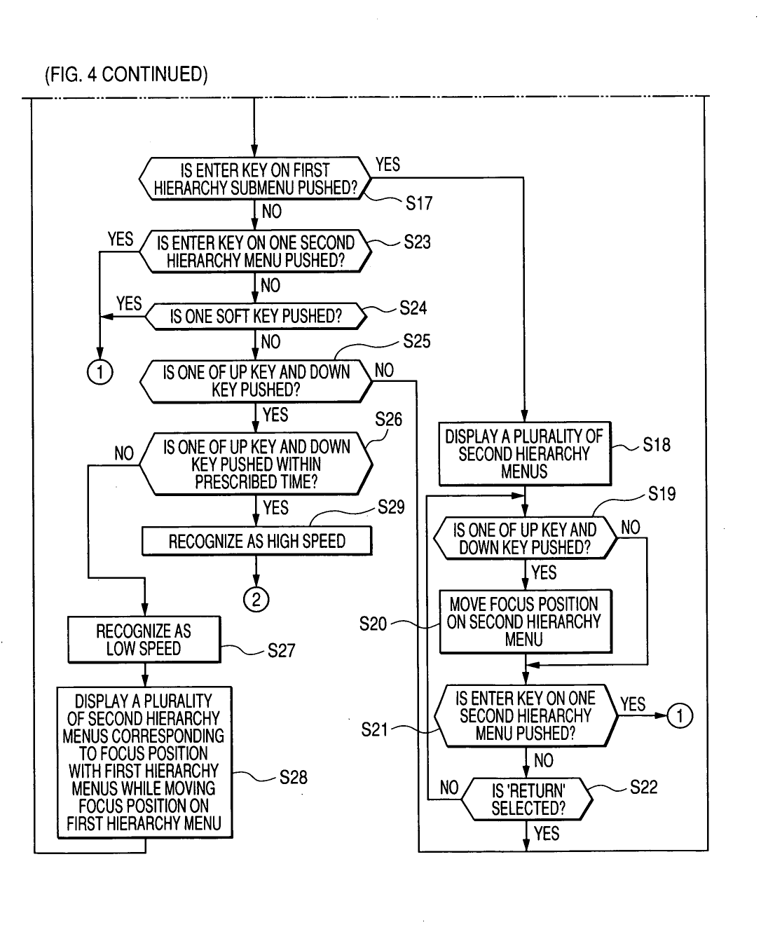

Next, a menu display control processing in the camera-equipped digital cellular phone 1 of FIG. 3 will be described with reference to FIG. 4. The menu display control processing starts when a plurality of first hierarchy menus are displayed on the liquid crystal display 17 in correspondence with the operation of the operating key 14 (for example, the enter key) by the user. Moreover, hierarchy menus having a plurality of hierarchies include, for example, first hierarchy menus, second hierarchy menus, and the like. The first hierarchy menus mean top hierarchy menus among the menus having the plurality of hierarchies.

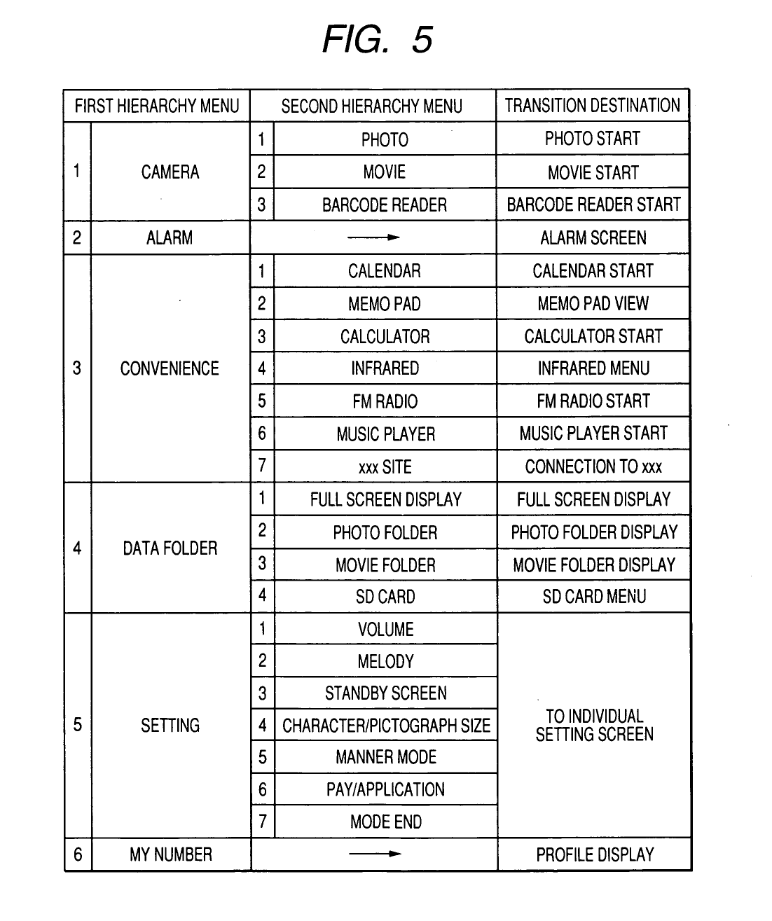

For example, as shown in FIG. 5, the first hierarchy menus include, for example, ‘CAMERA’, ‘ALARM’, ‘CONVENIENCE’, ‘DATA FOLDER’, ‘SETTING’, and ‘MY NUMBER’. Next, the second hierarchy menus associated with the first hierarchy menu ‘CAMERA’ includes ‘PHOTO’, ‘MOVIE’, and ‘BARCODE READER’. In each of the second hierarchy menus, for example, when the enter key is pushed, a transition to ‘PHOTO START’, ‘MOVIE START’, or ‘BARCODE READER START’ is made.

In the first hierarchy menu ‘ALARM’, no second hierarchy menu is prepared. For example, when the enter key is pushed in the first hierarchy menu ‘ALARM’, a transition to ‘ALARM SCREEN’ is made.

As the second hierarchy menus associated with the first hierarchy menu ‘CONVENIENCE’, ‘CALENDAR’, ‘MEMO PAD’, ‘CALCULATOR’, ‘INFRARED’, ‘FM RADIO’, ‘MUSIC PLAYER’, ‘xxx SITE’, and the like are provided. For example, when the enter key is pushed in each of the second hierarchy menus, a transition to ‘CALENDAR START’, ‘MEMO PAD VIEW’, ‘CALCULATOR START’, ‘INFRARED MENU’, ‘FM RADIO START’, ‘MUSIC PLAYER START’, or ‘CONNECTION TO xxx SITE’ is made.

As the second hierarchy menus associated with the first hierarchy menu ‘DATA FOLDER’, ‘FULL SCREEN DISPLAY’, ‘PHOTO FOLDER’, ‘MOVIE FOLDER’, and ‘SD CARD’ are provided. For example, when the enter key is pushed in each of the second hierarchy menus, a transition to ‘FULL SCREEN DISPLAY’, ‘PHOTO FOLDER DISPLAY’, ‘MOVIE FOLDER DISPLAY’, or ‘SD CARD MENU’ is made.

As the second hierarchy menus associated with the first hierarchy menu ‘SETTING’, ‘VOLUME’, ‘MELODY’, ‘STANDBY SCREEN’, ‘CHARACTER/PICTOGRAPH SIZE’, ‘MANNER MODE’, ‘PAY/APPLICATION’, and ‘MODE END’ are provided. For example, when the enter key is pushed in each of the second hierarchy menus, a transition to each of setting screens is made.

The first hierarchy menu ‘MY NUMBER’ has no second hierarchy menu. For example, when the enter key is pushed in the first hierarchy menu ‘MY NUMBER’, a transition to ‘PROFILE DISPLAY’ is made.

The above described hierarchy menus are defined as ‘hierarchy item information’. For example, the first hierarchy menus and the second hierarchy menus are defined as ‘first hierarchy item information’ and ‘second hierarchy item information’, respectively.

At Step S1, the main control unit 31 controls the LCD control unit 36 and displays a plurality of first hierarchy menus on the liquid crystal display 17. The liquid crystal display 17 displays the plurality of first hierarchy menus under the control of the LCD control unit 36.

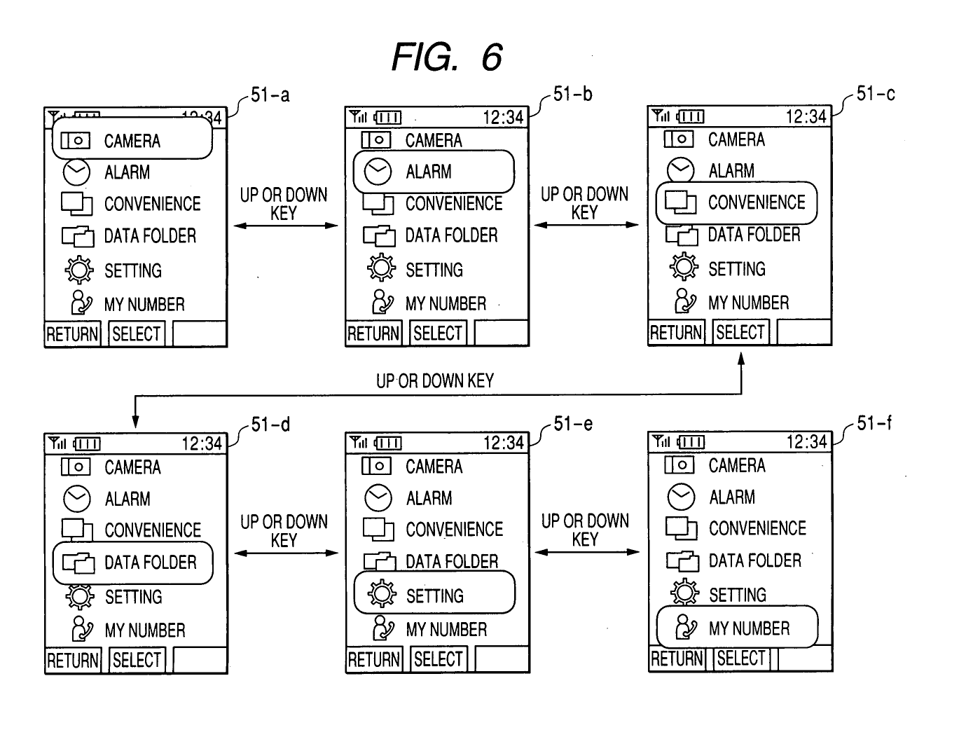

For example, like a display screen 51-a of FIG. 6, the plurality of first hierarchy menus, such as, ‘CAMERA’, ‘ALARM’, ‘CONVENIENCE’, ‘DATA FOLDER’, ‘SETTING’, and ‘MY NUMBER’ are displayed on the liquid crystal display 17. Further, each of the first hierarchy menus includes an icon (for example, an icon indicating a camera or the like) that indicates the corresponding menu. Further, in the display screen 51-a, the first hierarchy menu ‘CAMERA’ is focused among the plurality of first hierarchy menus (for example, ‘CAMERA’, ‘ALARM’, ‘CONVENIENCE’, ‘DATA FOLDER’, ‘SETTING’, and ‘MY NUMBER’).

At Step S2, the main control unit 31 judges whether or not a user pushes one of the operating keys 14, for example, one of an up key and a down key. At Step S2, if it is judged that the user pushes one of the operating keys 14, for example, one of the up key and the down key (directional key), at Step S3, the main control unit 31 controls the LCD control unit 36 to move a focus position of the plurality of first hierarchy menus displayed on the liquid crystal display 17. The liquid crystal display 17 moves the focus position of the plurality of first hierarchy menus under the control of the LCD control unit 36.

For example, in the display screen 51-a of FIG. 6, if the user pushes, for example, the down key among the operating keys 14, a transition to a display screen 51-b is made and the focus position of the plurality of first hierarchy menus (for example, ‘CAMERA’, ‘ALARM’, ‘CONVENIENCE’, ‘DATA FOLDER’, ‘SETTING’, and ‘MY NUMBER’) displayed on the liquid crystal display 17 moves from ‘CAMERA’ to ‘ALARM’. At the same time, if the user pushes, for example, the up key or the down key among the operating keys 14 on the display screen 51-b, a transition to the display screen 51-a or a display screen 51-c is made, and the focus position of the plurality of first hierarchy menus displayed on the liquid crystal display 17 moves from ‘ALARM’ to ‘CAMERA’ or ‘CONVENIENCE’.

In the display screen 51-c, if the user pushes, for example, the up key or the down key among the operating keys 14, a transition to the display screen 51-b or a display screen 51-d is made and the focus position of the plurality of first hierarchy menus displayed on the liquid crystal display 17 moves from ‘CONVENIENCE’ to ‘ALARM’ or ‘DATA FOLDER’. At the same time, if the user pushes, for example, the up key or the down key among the operating keys 14 on the display screen 51-d, a transition to the display screen 51-c or a display screen 51-e is made and the focus position of the plurality of first hierarchy menus displayed on the liquid crystal display 17 moves from ‘DATA FOLDER’ to ‘CONVENIENCE’ or ‘SETTING’. If the user pushes, for example, the up key or the down key among the operating keys 14 on the display screen 51-e, a transition to the display screen 51-d or a display screen 51-f is made and the focus position of the plurality of first hierarchy menus displayed on the liquid crystal display 17 moves from ‘SETTING’ to ‘DATA FOLDER’ or ‘MY NUMBER’.

At Step S2, if it is judged that the user does not press, for example, one of the up key or the down key (directional key) among the operating keys 14, Step S3 is skipped and the process progresses to Step S4.

At Step S4, when the user operates, for example, the enter key among the operating keys 14, the main control unit 31 judges whether or not the enter key is pushed on one first hierarchy menu among the plurality of first hierarchy menus displayed on the liquid crystal display 17.

At Step S4, when it is judged that the enter key is pushed on one the first hierarchy menu among the plurality of first hierarchy menus displayed on the liquid crystal display 17, at Step S5, the main control unit 31 controls the LCD control unit 36 to display the plurality of second hierarchy menus on the liquid crystal display 17. The liquid crystal display 17 displays the plurality of second hierarchy menus under the control of the LCD control unit 36.

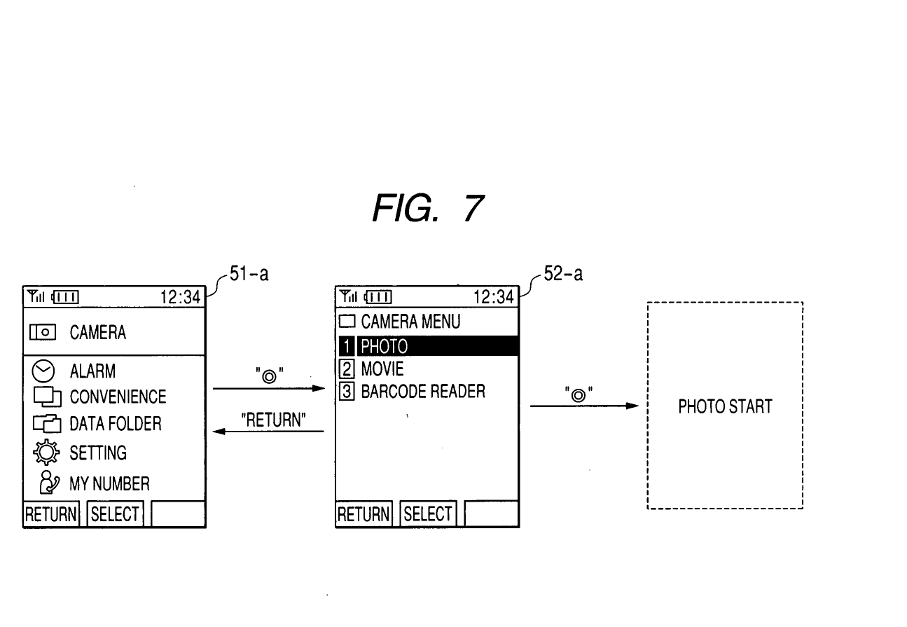

For example, as shown in FIG. 7, if the user pushes the enter key on the display screen 51-a (that is, the enter key is pushed on ‘CAMERA’ among the plurality of first hierarchy menus displayed on the liquid crystal display 17), a transition from the display screen 51-a to a display screen 52-a is made and the plurality of second hierarchy menus, such as ‘PHOTO’, ‘MOVIE’, and ‘BARCODE READER’, are displayed. At this time, ‘PHOTO’ among the plurality of second hierarchy menus is focused on the display screen 52-a.

At Step S6, the main control unit 31 determines whether or not the up key or the down key is pushed among the operating keys 14. At Step S6, if it is judged that the user pushes the up key or the down key among the operating keys 14, at Step S7, the main control unit 31 controls the LCD control unit 36 to move the focus position of the plurality of second hierarchy menus to be displayed on the liquid crystal display 17. The liquid crystal display 17 moves the focus position of the plurality of second hierarchy menus under the control of the LCD control unit 36.

For example, in the example of FIG. 7, if the user pushes the down key among the operating keys 14 on the display screen 52-a, the focus position of the plurality of second hierarchy menus (for example, ‘PHOTO’, ‘MOVIE’, and ‘BARCODE READER’) to be displayed on the liquid crystal display 17 moves from ‘PHOTO’ to ‘MOVIE’. Then, if the user further pushes the up key or the down key among the operating keys 14, the focus position of the plurality of second hierarchy menus to be displayed on the liquid crystal display 17 moves to one of ‘PHOTO’, ‘MOVIE’, and ‘BARCODE READER’.

At Step S6, if it is judged that the user does not press one of the up key and the down key among the operating keys 14, Step S7 is skipped and the process progresses to Step S8.

At Step S8, when the user operates, for example, the enter key among the operating keys 14, the main control unit 31 judges whether or not the enter key is pushed on one of the second hierarchy menus displayed on the liquid crystal display 17.

At Step S8, when it is judged that the enter key is pushed on one second hierarchy menu among the plurality of second hierarchy menus displayed on the liquid crystal display 17, the main control unit 31 controls execution of an application program associated with the corresponding second hierarchy menu (for example, ‘PHOTO’, ‘MOVIE’, or ‘BARCODE READER’), on which the enter key is pushed, in advance.

As shown in FIG. 7, if the user pushes the enter key on the second hierarchy menu of ‘PHOTO’ displayed on the liquid crystal display 17, the execution of an imaging application program associated with the second hierarchy menu of ‘PHOTO’ is controlled. Therefore, an imaging processing is executed using the CCD camera 20 and the menu display control processing ends.

At Step S8, when it is judged that the enter key is not pushed on one second hierarchy menu among the plurality of second hierarchy menus displayed on the liquid crystal display 17, at Step S10, the main control unit 31 judges whether or not ‘RETURN’ displayed on the liquid crystal display 17 is selected according to the operation of the soft 1 key among the operating keys 14 by the user.

At Step S10, if it is judged that ‘RETURN’ displayed on the liquid crystal display 17 is selected, the process returns to Step S1 and Steps S1 and later are repeated.

Further, in this case, when the plurality of first hierarchy menus are displayed at Step S1, the plurality of first hierarchy menus are displayed by refocusing the first hierarchy menu focused immediately before.

For example, as shown in FIG. 7, if it is judged that ‘RETURN’ is selected on the display screen 51-a, a transition from the display screen 51-a to the display screen 52-a is made again and only the plurality of first hierarchy menus are displayed. Further, the first hierarchy menu ‘CAMERA’ among the plurality of hierarchy menus is focused. Similarly, when the first hierarchy menu focused immediately before is ‘CONVENIENCE’, a transition to the display screen 51-c is made again.

At Step S10, when it is judged that ‘RETURN’ is not selected on the liquid crystal display 17, the process returns to Step S6 and Steps S6 and later are repeated.

Meanwhile, at Step S4, if it is judged that the enter key is not pushed on one of the first hierarchy menus displayed on the liquid crystal display 17, at Step S11, the main control unit 31 judges whether or not the first hierarchy menu is focused at the same focus position for a prescribed time (for example, two seconds) or more.

Further, at Step S11, the main control unit 31 may judge whether or not a prescribed time (for example, two seconds) lapses from when the user pushes the key, instead of judging whether or not the first hierarchy menu is focused at the same focus position for the prescribed time (for example, two seconds) or more.

At Step S11, if it is judged that the first hierarchy menu is not focused at the same focus position for the prescribed time (for example, two seconds) or more (that is, it is judged that the first hierarchy menu is focused at the same focus position for less than the prescribed time (for example, two seconds)), at Step S12, the main control unit 31 recognizes that the focus moves at high speed. Thereafter, the process progresses to Step S2 and Steps S2 and later are repeated.

Accordingly, if the up key or the down key is pushed at high speed by the user while the first hierarchy menu is not focused at the same focus position for the prescribed time (for example, two seconds) or more, for example, as shown in FIG. 6, only the plurality of first hierarchy menus are displayed on the liquid crystal display 17, the focus position moves on the first hierarchy menus according to the operation of the up key or the down key.

Therefore, when the user want to change the focus position at high speed, only the first hierarchy menus are displayed instead of simultaneously displaying different hierarchy menus so as to move the focus position at high speed.

Even though the up key or the down key among the operating keys 14 are repeatedly pushed at high speed by the user (continuously pushed with no separation), it is judged that the up key or the down key among the operating keys 14 is pushed at high speed by the user while the first hierarchy menu is not focused at the same focus position for the prescribed time (for example, two seconds) or more. Then, only the plurality of first hierarchy menus are displayed on the liquid crystal display 17, and the focus position moves on the first hierarchy menus according to the operation of the up key or the down key, as shown in FIG. 6.

Meanwhile, at Step S11, if it is judged that the first hierarchy menu is focused at the same focus position for the prescribed time (for example, two seconds) or more, at Step S13, the main control unit 31 recognizes that the focus moves at low speed.

Further, at Steps S11 and S13, the main control unit 31 recognizes that the focus moves at low speed by judging whether or not the first hierarchy menu is focused at the same focus position for the prescribed time (for example, two seconds) or more. However, the invention is not limited thereto. For example, the main control unit 31 may recognize that the focus moves at low speed or at high speed by judging whether or not the focus movement speed is smaller than a prescribed reference value.

At Step S14, the main control unit 31 controls the LCD control unit 36 to display the plurality of second hierarchy menus (a part or all of the second hierarchy menus) at the focus position on the liquid crystal display 17 while displaying the first hierarchy menus. The liquid crystal display 17 displays the plurality of second hierarchy menus and the first hierarchy menus at the same time under the control of the LCD control unit 36.

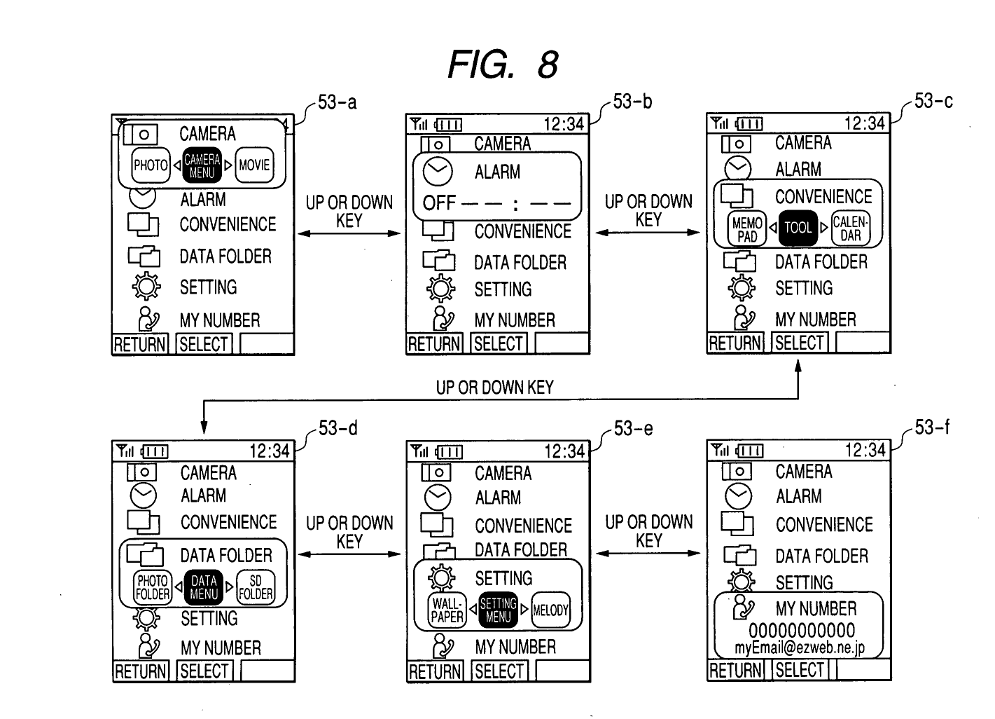

For example, in the display screen 51-a shown in FIG. 6, if it is judged that the first hierarchy menu is focused at the same focus position for the prescribed time or more and it is recognized that the focus movement speed is low, a plurality of second hierarchy menus, such as ‘PHOTO’ and ‘MOVIE’ are displayed together with the first hierarchy menu ‘CAMERA’ at the focus position, like the display screen 53-a shown in FIG. 8. In particular, in the display screen 53-a shown in FIG. 8, below the first hierarchy menu ‘CAMERA’, ‘CAMERA MENU’ is displayed as a first hierarchy submenu that is detailed information of the first hierarchy menu ‘CAMERA’, and the ‘PHOTO’ and the ‘MOVIE’ as the second hierarchy menus are displayed on the left and right sides of the first hierarchy submenu ‘CAMERA MENU’, respectively. In addition, in the display screen 53-a, a first hierarchy submenu ‘CAMERA MENU’ among the first hierarchy submenu (for example, ‘CAMERA MENU’) and the plurality of second hierarchy menus (for example, ‘PHOTO’ and ‘MOVIE’) is focused.

Therefore, the different menus (for example, the first hierarchy menus and the second hierarchy menus) can be displayed at the same time. Accordingly, the user can grasp the different hierarchy menus at the same time and can easily understand which processing is to be subsequently executed among the hierarchy menus displayed at the current focus position. As a result, it is possible to improve operationality of the camera-equipped digital cellular phone 1.

Hereinafter, the first hierarchy submenu (for example, ‘CAMERA MENU’ or the like) is defined as ‘first hierarchy sub item information’.

Here, in the display screen 53-a shown in FIG. 8, a representative menu (for example, ‘PHOTO’ or ‘MOVIE’) among the second hierarchy menus (for example, ‘PHOTO’, ‘MOVIE’, ‘BARCODE READER, and the like) associated with the first hierarchy menu ‘CAMERA’ is displayed together with the first hierarchy menu. However, as shown in FIG. 5, when a plurality of second hierarchy menus are associated with the first hierarchy menu, a scroll function may be used in the horizontal direction such that the second hierarchy menus displayed at the focus position can be sequentially displayed.

At Step S15, the main control unit 31 judges whether or not the user pushes one of a left key and a right key among the operating keys 14. At Step S15, if it is judged that the user pushes one of the left key and the right key among the operating keys 14, the main control unit 31 controls the LCD control unit 36 to move the focus position of the first hierarchy submenu and the second hierarchy menus displayed on the liquid crystal display 17. The liquid crystal display 17 moves the focus position of the first hierarchy submenu and the second hierarchy menus under the control of the LCD control unit 36.

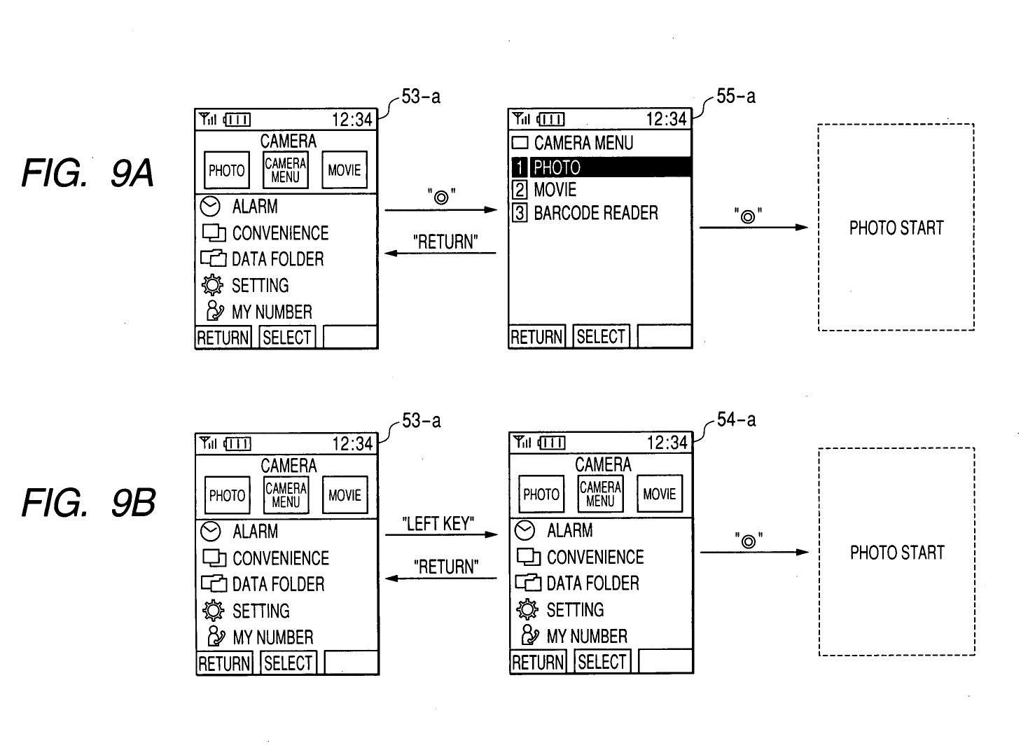

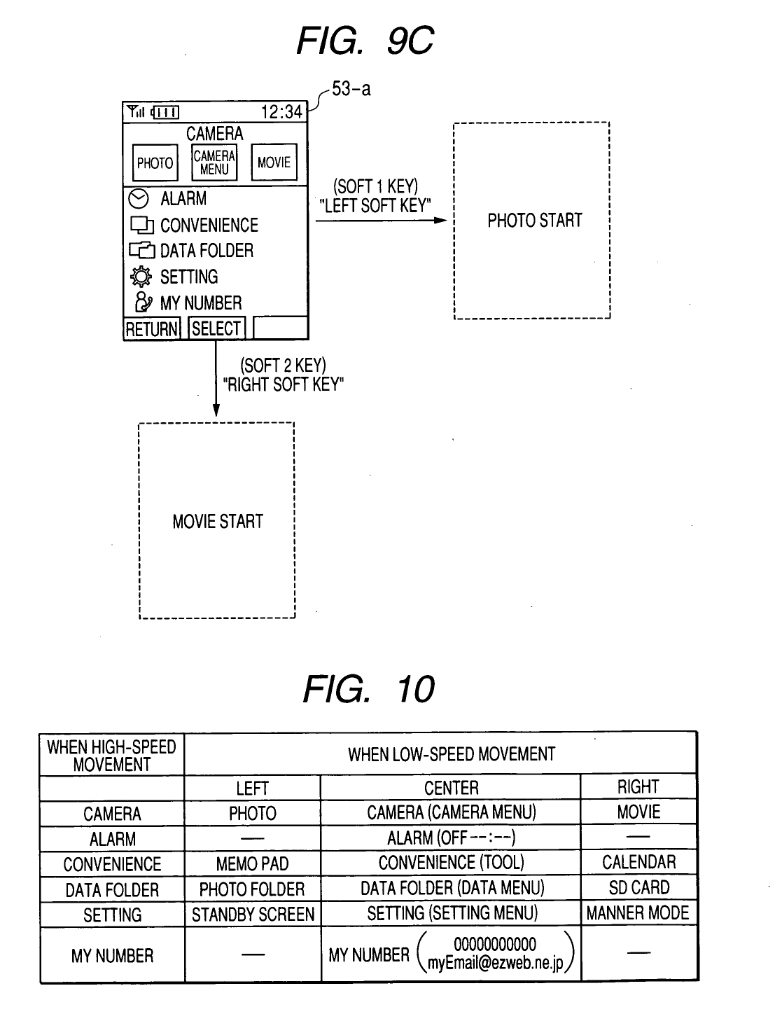

For example, as shown in FIG. 9B, if the user pushes one of the left key and the right key among the operating keys 14 on the display screen 53-a, a transition to a display screen 54-a is made. Further, the focus position in the first hierarchy submenu (for example, ‘CAMERA MENU’) and the second hierarchy menus (for example, ‘PHOTO’ and ‘MOVIE’) displayed on the liquid crystal display 17 moves from ‘CAMERA MENU’ to ‘PHOTO’.

Further, in FIG. 9B, if the user pushes the right key among the operating keys 14 on the display screen 53-a, the focus position in the first hierarchy submenu (for example, ‘CAMERA MENU’) and the second hierarchy menus (for example, ‘PHOTO’ and ‘MOVIE’) displayed on the liquid crystal display 17 moves from ‘CAMERA MENU’ to ‘MOVIE’.

At Step S17, if the user pushes the enter key among the operating keys 14, the main control unit 31 judges whether or not the enter key in the first hierarchy submenu displayed on the liquid crystal display 17 is pushed.

At Step S17, if it is judged that the enter key in the first hierarchy submenu displayed on the liquid crystal display 17 is pushed, at Step S18, the main control unit 31 controls the LCD control unit 36 to display the plurality of second hierarchy menus on the liquid crystal display 17. The liquid crystal display 17 displays the plurality of second hierarchy menus under the control of the LCD control unit 36.

For example, as shown in FIG. 9A, if the user pushes the enter key on the display screen 53-a (that is, the enter key is pushed on ‘CAMERA’ among the plurality of first hierarchy submenus displayed on the liquid crystal display 17), a transition to from the display screen 53-a a display screen 55-a is made and the plurality of second hierarchy menus, such as ‘PHOTO’, ‘MOVIE’, and ‘BARCODE READER’, are displayed. At this time, the second hierarchy menu ‘PHOTO’ among the plurality of second hierarchy menus on the display screen 55-a is focused.

At Step S19, the main control unit 31 judges whether or not the user pushes one of the up key and the down key among the operating keys 14. At Step S19, if it is judged that the user pushes one of the up key and the down key among the operating keys 14, at Step S20, the main control unit 31 controls the LCD control unit 36 to move the focus position of the plurality of second hierarchy menus to be displayed on the liquid crystal display 17. The liquid crystal display 17 moves the focus position of the plurality of second hierarchy menus under the control of the LCD control unit 36.

For example, in the example of FIG. 9A, if the user pushes the down key among the operating keys 14 on the display screen 55-a, the focus position of the plurality of second hierarchy menu (for example, ‘PHOTO’, ‘MOVIE’, or ‘BARCODE READER’) to be displayed on the liquid crystal display 17 moves from ‘PHOTO’ to ‘MOVIE’. Thereafter, if the user pushes the up key among the operating keys 14, the focus position of the plurality of second hierarchy menu to be displayed on the liquid crystal display 17 moves to one of ‘PHOTO’, ‘MOVIE’, and ‘BARCODE READER’.

At Step S19, if it is judged that the user does not push one of the up key and the down key among the operating keys 14, Step S20 is skipped and the process progresses to Step S21.

At Step S21, when the user operates, for example, the enter key among the operating keys 14, the main control unit 31 judges whether or not the enter key is pushed on one of the second hierarchy menus displayed on the liquid crystal display 17.

At Step S21, when it is judged that the enter key is pushed on one second hierarchy menu among the plurality of second hierarchy menus displayed on the liquid crystal display 17, the process progresses to Step S9. At Step S9, the main control unit 31 controls the execution of an application program associated with the second hierarchy menu (for example, ‘PHOTO’, ‘MOVIE’, or ‘BARCODE READER’), on which the enter key is pushed, in advance.

As shown in FIG. 9A, if the user pushes the enter key on the second hierarchy menu ‘PHOTO’ displayed on the liquid crystal display 17, the execution of an imaging application program associated with the second hierarchy menu ‘PHOTO’ is controlled. Therefore, an imaging processing is executed using the CCD camera 20 and the menu display control processing ends.

At Step S21, when it is judged that the enter key is not pushed on one second hierarchy menu among the plurality of second hierarchy menus displayed on the liquid crystal display 17, at Step S22, the main control unit 31 judges whether or not ‘RETURN’ displayed on the liquid crystal display 17 is selected according to the operation of the soft 1 key among the operating keys 14 by the user.

At Step S22, if it is judged that ‘RETURN’ displayed on the liquid crystal display 17 is selected, the process returns to Step S14 and Steps S1 and later are repeated. In this case, at Step S14, if the second hierarchy menus are simultaneously displayed with the first hierarchy menu, the first hierarchy menu focused immediately before are focused again, such that the plurality of second hierarchy menus are displayed together with the first hierarchy menus.

That is, a transition from the display screen 55-a to the display screen 53-a is made and the second hierarchy menus ‘PHOTO’ and ‘MOVIE’ are displayed together with the first hierarchy menu ‘CAMERA’ so as to focus the first hierarchy submenu ‘CAMERA MENU’.

At Step S22, when it is judged that ‘RETURN’ is not selected on the liquid crystal display 17, the process returns to Step S19 and Steps S6 and later are repeated.

Meanwhile, at Step S17, if it is judged that the enter key is not pushed on the first hierarchy submenu displayed on the liquid crystal display 17, at Step S23, the main control unit 31 judges whether or not the enter key is pushed on one of the plurality of second hierarchy menus (for example, ‘PHOTO’ or ‘MOVIE’) displayed on the liquid crystal display 17 according to the operation of the enter key among the operating keys 14 by the user.

At Step S23, if it is judged that the enter key is pushed on one of the plurality of second hierarchy menus displayed on the liquid crystal display 17, the process progresses to Step S9. At Step S9, the main control unit 31 controls the execution of an application program associated with the second hierarchy menu (for example, ‘PHOTO’, ‘MOVIE’, or ‘BARCODE READER’), on which the enter key is pushed, in advance.

As shown in FIG. 9B, if the user pushes the enter key on the second hierarchy menu ‘PHOTO’ displayed on the liquid crystal display 17, the execution of an imaging application program associated with the second hierarchy menu ‘PHOTO’ is controlled. Therefore, an imaging processing is executed using the CCD camera 20 and the menu display control processing ends.

At Step S23, when it is judged that the enter key is not pushed on one second hierarchy menu among the plurality of second hierarchy menus displayed on the liquid crystal display 17, at Step S24, the main control unit 31 judges whether or not the soft key is pushed according to the operation of the soft 1 key or the soft 2 key among the operating keys 14 by the user.

At Step S24, if it is judged that one of the soft keys (the soft 1 key and the soft 2 key) is pushed, the process progresses to Step S9 and the main control unit 31 controls the execution of an application program associated with the second hierarchy menu (for example, ‘PHOTO’ or ‘MOVIE’) corresponding to a position of the pushed soft key where the enter key is pushed.

As shown in FIG. 9C, if the user pushes the soft 1 key, the execution of an imaging application program associated with the second hierarchy menu ‘PHOTO’ corresponding to the position of the pushed soft 1 key is controlled. Therefore, an imaging processing is executed using the CCD camera 20 and the menu display control processing ends.

If the user pushes the soft 2 key, the execution of a motion picture imaging application program associated with the second hierarchy menu ‘MOVIE’ corresponding to the position of the pushed soft 2 key is controlled. Therefore, a motion picture image processing is executed using the CCD camera 20 and the menu display control processing ends.

Therefore, the user can easily start a desired application program and execute a desired processing using the hierarchy menus (the first hierarchy menus or the second hierarchy menus).

At Step S24, when it is judged that one of the soft keys (the soft 1 key and the soft 2 key) is not pushed, at Step S25, the main control unit 31 judges whether or not the user pushes one of the up key and the down key among the operating keys 14.

At Step S25, if it is judged that the user pushes one of the up key and the down key among the operating keys 14, at Step S26, the main control unit 31 judges whether or not one of the up key and the down key is pushed within a prescribed time (for example, one second). In particular, at Step S14, after the plurality of second hierarchy menus are displayed with the first hierarchy menu at the focus position, if the up key or the down key is not pushed by the user, the main control unit 31 judges whether or not the up key or the down key is pushed within the prescribed time (for example, one second) after the second hierarchy menus and the first hierarchy menu are displayed.

Further, at Step S26, instead of judging whether or not the up key or the down key is pushed within the prescribed time (for example, one second), it may be judged whether or not the prescribed time (for example, one second) lapses after the user pushes the key immediately before.

At Step S26, if it is judged that the up key or the down key is not pushed within the prescribed time (for example, one second), at Step S27, the main control unit 31 recognizes that the focus movement speed is low. Moreover, the prescribed time (for example, one second) at Step S26 may be identical to or different from the prescribed time (for example, two second) at Step S11.

At Step S28, the main control unit 31 controls the LCD control unit 36 to display the plurality of second hierarchy menus at the focus position on the liquid crystal display 17 while simultaneously moving the focus position on the first hierarchy menu. The liquid crystal display 17 displays the plurality of second hierarchy menus at the focus position together with the first hierarchy menu under the control of the LCD control unit 36 while moving the focus position on the first hierarchy menu.

For example, in the display screen 53-a shown in FIG. 8, if it is judged that the user pushes the down key among the operating keys 14 but the up key or the down key is not pushed within the prescribed time (for example, one second), and it is recognized that the focus movement speed is low, a transition to a display screen 53-b is made and the focus position in the plurality of first hierarchy menus (for example, ‘CAMERA’, ‘ALARM’, ‘CONVENIENCE’, ‘DATA FOLDER’, ‘SETTING’, and ‘MY NUMBER’) to be displayed on the liquid crystal display 17 moves from ‘CAMERA’ to ‘ALARM’. Further, the plurality of second hierarchy menus at the focus position are displayed on the liquid crystal display 17 together with the first hierarchy menu.

For example, in the display screen 53-b, a first hierarchy submenu ‘OFF-:-’ is displayed together with the first hierarchy menu ‘ALARM’ at the focus position. Further, in the display screen 53-b, the first hierarchy submenu ‘OFF-:-’ is focused.

Similarly, in the display screen 53-b, if it is judged that the user pushes the up key or the down key among the operating keys 14, a transition to the display screen 53-a or the display screen 53-c is made and the focus position in the plurality of first hierarchy menus to be displayed on the liquid crystal display 17 moves from ‘ALARM’ to ‘CAMERA’ or ‘CONVENIENCE’. For example, if the user pushes the down key among the operating keys 14 on the display screen 53-b, a transition to the display screen 53-c is made and the plurality of second hierarchy menus ‘MEMORY PAD’ and ‘CALENDAR’ are displayed at the focus position together with the first hierarchy menu ‘CONVENIENCE’ on the liquid crystal display 17. In particular, in the display screen 53-c of FIG. 8, below the first hierarchy menu ‘CONVENIENCE’, a first hierarchy submenu ‘TOOL’ that is detailed information of the first hierarchy menu ‘CONVENIENCE’ is displayed and second hierarchy menus ‘MEMO PAD’ and ‘CALENDAR’ are simultaneously displayed at both sides of the first hierarchy submenu ‘TOOL’. Further, in the display screen 53-c, the first hierarchy submenu ‘TOOL’ among the first hierarchy submenu (for example, ‘TOOL’) and the second hierarchy menus (for example, ‘MEMO PAD’ and ‘CALENDAR’) is focused.

In the display screen 53-c, if the user pushes the up key or the down key among the operating keys 14, a transition to the display screen 53-b or a display screen 53-d is made and the focus position in the plurality of first hierarchy menus to be displayed on the liquid crystal display 17 moves from ‘CONVENIENCE’ to ‘ALARM’ or ‘DATA FOLDER’. For example, if the user pushes the down key among the operating keys 14 on the display screen 53-c, a transition to the display screen 53-d is made and a plurality of second hierarchy menus ‘PHOTO FOLDER’ and ‘SD FOLDER’ are displayed at the focus position together with the first hierarchy menu ‘DATA FOLDER’. In particular, in the display screen 53-d of FIG. 8, below the first hierarchy menu ‘DATA FOLDER’, a first hierarchy submenu ‘DATA MENU’ that is detailed information of the first hierarchy menu ‘DATA FOLDER’ is displayed and the second hierarchy menus ‘PHOTO FOLDER’ and ‘SD FOLDER’ are simultaneously displayed at both sides of the first hierarchy submenu ‘DATA MENU’. Further, in the display screen 53-d, the first hierarchy submenu ‘DATA MENU’ among the first hierarchy submenu (for example, ‘DATA MENU’) and the second hierarchy menus (for example, ‘PHOTO FOLDER’ and ‘SD FOLDER’) is focused.

The same is applied to others, and the description will be omitted.

Therefore, it is judged that it is focused for the prescribed time (for example, two seconds) or more at the same focus position. If the user pushes the up key or the down key among the operating keys 14 once at low speed, it is possible to display the plurality of second hierarchy menus together with the first hierarchy menu at the focus position until the user pushes the up key or the down key among the operating keys 14 at high speed. As a result, it is possible to display different kinds of menus at the same time.

Accordingly, the user can grasp menus of different hierarchies at the same time so as to easily and simply understand a processing to be subsequently executed in a hierarchy menu displayed at the current focus position. As a result, it is possible to improve operationality of the camera-equipped digital cellular phone 1.

At Step S26, when it is judged that the up key or the down key is pushed within the prescribed time (for example, one second), at Step S29, the main control unit 31 recognizes that the focus movement speed is high.

Thereafter, the process progresses to Step S3 and Step S3 and later are repeated.

For example, when the display screen 53-a of FIG. 8 is displayed on the liquid crystal display 17, if the user pushes the up key or the down key within a prescribed time (for example, one second) and it is judged that the focus movement speed is high, a transition from the display screen 53-a of FIG. 8 to the display screen 51-b of FIG. 6 is made. Further, at the focus position, the screen on which plurality of second hierarchy menus and the first hierarchy menu are displayed at the same time is switched to a display screen on which only the plurality of first hierarchy menus are displayed. In addition, the focus position moves from ‘CAMERA’ to ‘ALARM’.

Therefore, it is judged that the menu is focused for the prescribed time (for example, two seconds) or more at the same focus position, and the user pushes the up key or the down key among the operating keys 14 once at low speed. Then, after the first hierarchy menu and the plurality of second hierarchy menus are displayed at the same time at the focus position, when the user pushes the up key or the down key among the operating keys 14 at high speed, for example, as shown in FIG. 6, only the plurality of first hierarchy menus can be displayed on the liquid crystal display 17, and the focus position in the first hierarchy menus can move according to the operation of the up key or the down key. Therefore, when the user wants to move the focus position at high speed after moving the focus position at low speed, only the first hierarchy menus are displayed according to the favorite of the user without displaying menus of different hierarchies at the same time. Therefore, it is possible to move the focus position at high speed.

Accordingly, it is possible to improve operationality of the camera-equipped digital cellular phone 1.

Meanwhile, at Step S25, if it is judged that the user does not push one of the up key and the down key among the operating keys 14, the process returns to Step S15 and Steps S15 and later are repeated.

Here, referring to FIG. 10, the hierarchy menus to be displayed on the liquid crystal display 17 will be described when the focus movement speed is high and low.

As shown in FIG. 10, when the focus movement speed is high, only the plurality of first hierarchy menus are displayed on the liquid crystal display 17. That is, the first hierarchy menus, for example, ‘CAMERA’, ‘ALARM’, ‘CONVENIENCE’, ‘DATA FOLDER’, ‘SETTING’, and ‘MY NUMBER’ are displayed and the focus position moves according to the operation by the user.

Meanwhile, when the focus movement speed is low, the plurality of first hierarchy menus are displayed on the liquid crystal display 17, and the first hierarchy menu (including the first hierarchy sub item information) and the plurality of second hierarchy menus are displayed at the focus position at the same time. In particular, the first hierarchy menu (including the first hierarchy sub item information) is displayed at the center and the second hierarchy menus are displayed at both sides of the first hierarchy menu.

According to the embodiment, it is judged whether or not the menu is focused for a prescribed time or more at the same focus position. When it is determined that the menu is focused for the prescribed time or more at the same focus position, it is recognized that the focus movement speed is low and the first hierarchy menus and the second hierarchy menus are displayed at the same time at the focus position. Accordingly, it is possible to display different hierarchy menus at the same time. Therefore, the user can grasp the different hierarchy menus at the same time and can easily understand which processing is to be subsequently executed among the hierarchy menus displayed at the current focus position. As a result, it is possible to improve operationality of the camera-equipped digital cellular phone 1.

Further, in the menu display control processing described with reference to the flowchart of FIG. 4, it is judged whether or not the menu is focused for the prescribed time or more at the same focus position. After the user pushes the up key or the down key once at low speed, the first hierarchy menus are displayed together with the second hierarchy menus at the focus position at the same time until the user pushes the up key or the down key at high speed. However, the invention is not limited thereto. For example, only when it is judged that the menu is focused for the predetermined time (for example, two seconds) or more at the same focus position, it may be recognized that the focus movement speed is low and then the first hierarchy menu and the plurality of second hierarchy menus may be displayed at the same time at the focus position. Hereinafter, the menu display control processing will be described using the above-described method.

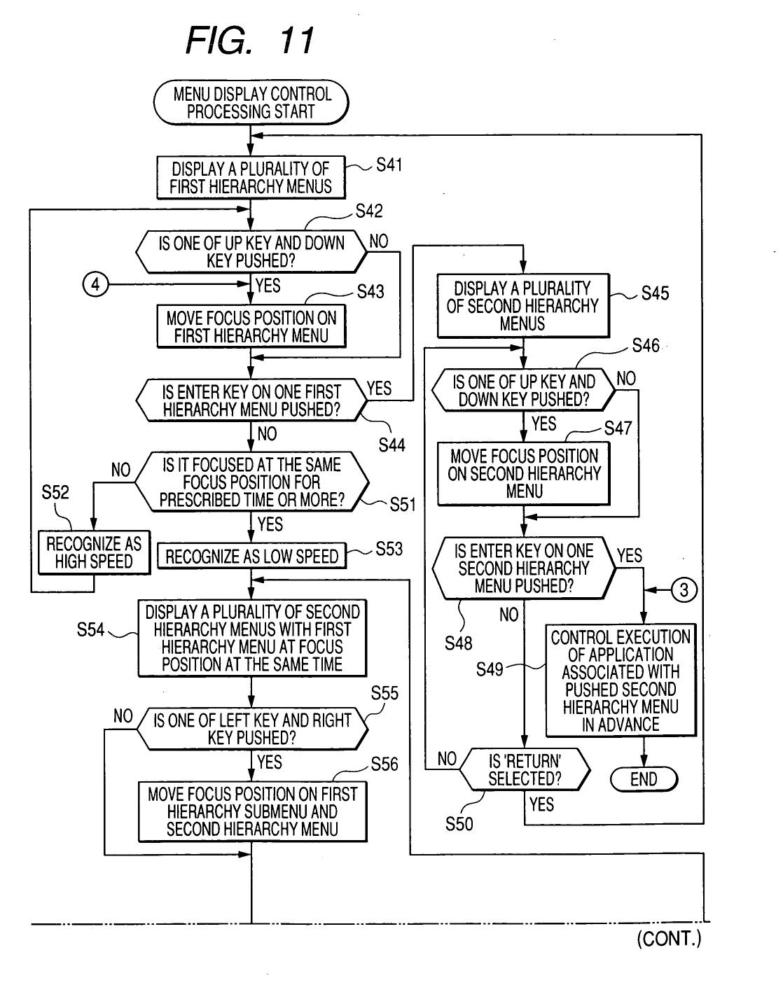

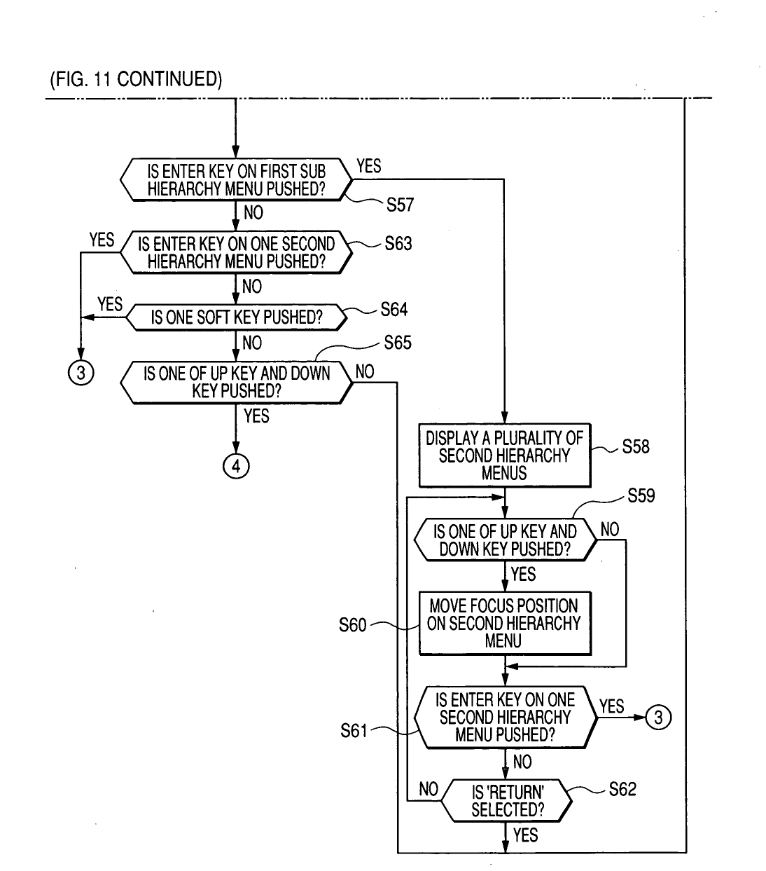

With reference to a flowchart of FIG. 11, another menu display control processing of the camera-equipped digital cellular phone 1 of FIG. 3 will be described using the above-described method. Further, Steps S41 to S64 of FIG. 11 are basically the same as Steps S1 to S24 of FIG. 4, and thus the descriptions thereof will be omitted.

At Step S65, when it is judged that the user does not push one of the up key and the down key among the operating keys 14, the process returns to Step S55 and Steps S55 and later are repeated.

At Step S65, when it is judged that the user pushes one of the up key and the down key among the operating keys 14, the process progresses to Step S43 and Steps S43 and later are repeated.

For example, when the display screen 53-a of FIG. 8 is displayed on the liquid crystal display 17, if the user pushes one of the up key and the down key among the operating keys 14, a transition from the display screen 53-a of FIG. 8 to the display screen 51-b of FIG. 6 is made. Further, the display screen on which the plurality of second hierarchy menus and the first hierarchy menu are displayed at the focus position at the same time is switched to the display screen on which only the plurality of first hierarchy menus are displayed at the focus position and the focus position moves from ‘CAMERA’ to ‘ALARM’.

Therefore, unless it is judged that the menu is focused for the prescribed time (for example, two seconds) or more at the same focus position, it is possible to move the focus position at high speed by displaying only the first hierarchy menus without displaying menus of the different hierarchies at the same time. Therefore, it is possible to improve operationality of the camera-equipped digital cellular phone 1.

According to the embodiment, the first hierarchy menu and the second hierarchy menus are displayed at the focus position at the same time. However, the second hierarchy menus may be displayed on the left side of the first hierarchy menu and a third hierarchy menu may be displayed on the right side of the first hierarchy menu. Accordingly, the user can grasp different hierarchy menus at the same time and can easily understand which processing is to be subsequently executed among the hierarchy menus displayed at the current focus position. As a result, it is possible to improve operationality of the camera-equipped digital cellular phone 1.

The embodiment may be applied to a PDA (Personal Digital Assistant), a personal computer, and other information processing apparatus, in addition to the camera-equipped digital cellular phone 1.

According to the embodiment, a series of processing may be executed by software or may be executed by hardware.

Although an example where the steps of the flowchart are performed in time series according to the described sequence in the embodiment of the invention, the steps may be not necessarily performed in time series. For example, the steps may be performed in parallel or individually.

What is claimed is:

1. An information processing apparatus comprising:
a display unit configured to display a plurality of informations having a plurality of hierarchies;
a focus control unit configured to focus at least one of the plurality of informations to be displayed by the display unit;
a recognition unit configured to recognize whether or not a focus movement speed in at least one of the plurality of informations controlled by the focus control unit is smaller than a prescribed reference value; and
a first control unit configured to control the display unit to display at least one of the plurality of informations according to the recognition result by the recognition unit.

2. The information processing apparatus according to claim 1,
wherein at least one of the plurality of informations comprises a first information and a second information, and
the first control unit controls the display unit to display the first information and the second information at the same time when the recognition unit recognizes that the focus movement speed in the first information by the focus control unit is smaller than the prescribed reference value.

3. An information processing apparatus comprising:
a display unit configured to display a plurality of informations having a plurality of hierarchies;
a focus control unit configured to focus at least one of the plurality of informations to be displayed by the display unit;
a focus time judgment unit configured to judge whether or not the same information is focused by the focus control unit for a prescribed time or more; and
a first control unit configured to control the display unit to display at least one of the plurality of informations according to a judgment result by the focus time judgment unit.

4. The information processing apparatus according to claim 3,
wherein the plurality of informations comprises a first information and a second information having a hierarchy lower than a hierarchy of the first information, and
the first control unit controls the display unit to display the first information and the second information at the same time when the focus time judgment unit judges that the same hierarchy item information is focused by the focus unit for the prescribed time or more.

5. The information processing apparatus according to claim 4, wherein the first hierarchy item information is displayed in a first direction, and
wherein the second information is displayed in a second direction which is different from the first direction.

6. The information processing apparatus according to claim 5, wherein the first and second directions are horizontal and vertical directions.

7. The information processing apparatus according to claim 4, wherein the at least one of the plurality of informations further comprises a third information and a fourth information having a hierarchy lower than the third information,
wherein the first and third informations have the same hierarchy,
wherein the second and fourth informations have the same hierarchy, and
wherein, after the prescribe time has passed since the first information and the second information are simultaneously displayed, the third information and the fourth information are simultaneously displayed based on a predetermined case.

8. The information processing apparatus according to claim 7, wherein the predetermined case is that a user presses a predetermined key.

9. The information processing apparatus according to claim 3,
wherein the plurality of informations comprises a first information and a second information, and
the first control unit controls the display unit to display the first information and the second information at the same time when the focus time judgment unit judges that the same information is focused by the focus control unit for the prescribed time or more.

10. The information processing apparatus according to claim 1, further comprising:
a second control unit configured to control execution of an application program associated with the plurality of informations to be displayed by the display unit in advance.

11. The information processing apparatus according to claim 3, further comprising:
a second control unit configured to control execution of an application program associated with the plurality of informations to be displayed by the display unit in advance.
